(19) United States
(12) Patent Application Publication
(10) Pub. No.: US 2025/0345969 A1
(43) Pub. Date: Nov. 13, 2025

(54) NOVEL PRESSURIZED FOAM CEMENT BLENDER UTILIZING GAS FOR LABORATORY SLURRY OPTIMIZATION

(71) Applicant: Aramco Services Company, Houston, TX (US)

(72) Inventors: Kenneth Dejuan Johnson, Tomball, TX (US); Rolando F. Martinez, Katy, TX (US); Ashok Santra, The Woodlands, TX (US)

(73) Assignee: Aramco Services Company, Houston, TX (US)

(21) Appl. No.: 18/659,324

(22) Filed: May 9, 2024

(51) Int. Cl. B28C 5/38; C04B 38/10; C04B 40/00; C04B 103/40

(52) U.S. Cl. CPC B28C 5/388; C04B 38/103; C04B 40/0032; C04B 2103/40

(57) ABSTRACT

Apparatus, systems, and methods for preparing foam cement compositions in a laboratory are disclosed. The apparatus includes a blender body, a base connector, an inlet port, a test port, an outlet port, a blender blade apparatus, and a blender cap. Systems to prepare foam cement compositions in a laboratory, include the apparatus, a first tubing assembly threaded to the inlet port configured to receive a pressurized gas and provide the pressurized gas to the apparatus, a second tubing assembly threaded to the test port, and a motorized base. Methods for preparing a foam cement composition using the apparatus for preparing foam cement compositions in a laboratory include adding a cement composition to the apparatus, fitting a blender cap on the apparatus, mixing the cement composition, and providing a pressurized gas and surfactant to the cement composition to produce a foam cement composition.

### BACKGROUND

As an application for wellbore stability, foam cementing was developed in the late 1970s as a low-density cementing alternative to lower cost associated with multi-stage cementing. Before the inception of foam cementing, primary cementing was the go-to method to control gas mitigation and provide wellbore stability for wells with mid to high fracture gradients. However, brittleness or lack of ductility of conventional cement has been identified as one of the primary failure mechanisms of primary cement jobs. Additionally, conventional cement has a relatively high density. For example, the standard density of a Class G Portland cement is 15.8 ppg (pounds per gallon), while Class H Portland cement has a density of 16.4 ppg (pounds per gallon). When cementing a well, if the formation requires low density materials for well support, the density of common cements like Class H and Class G Portland cement may be lowered to protect the well formation from hydraulic fracturing during cementing. However, lowering the density of these cements has typically been done at the expense of the cement strength. For example, a conventional method for lowering the density of cement includes adding more water to the cement mix to reach the desired density. However, adding water to decrease the density of a cement slurry also lowers the compressive strength of the cement significantly.

Foam cementing includes placing relatively high-strength, lightweight (6 to 11 ppg) and economical cement slurries into the casing-formation annulus. In foam cementing, gas is introduced to the cement slurry in order to lower the density of the cement, instead of water. Since the density of gas is much lower than the density of water, less gas is needed to lower the density of cement, giving less impact on the physical properties of the cement.

After the BP oil spill, many problems associated with induced fractures in a wellbore from cementing were learned, for example that hydraulic fractures could form if the hydraulic pressure from cementing exceeds the formation's pore pressure, which may lead to a well blowout. With the proper understanding of field parameters and processes, a successful cementing operation can be determined based on the specific field requirements. For example, in a field having low-density formations, heavy weight Class H and Class G cements can potentially fracture the low-density formations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an apparatus for preparing foam cement compositions in a laboratory, including a blender body, having a blender body wall extending around a central volume and defining an inner diameter of the blender body, a first end comprising a threaded connection, a second end comprising a base connector, an inlet port formed through the blender body wall, a test port, an outlet port formed through the blender body wall. The apparatus also includes a blender blade apparatus, including a central shaft having a first axial end and a second axial end having a threaded portion, and a multi-blade assembly provided along the central shaft, where the central shaft is provided within the central volume of the blender body and threadedly connected to the blender body at the threaded portion. The apparatus also includes a blender cap, including a cap first end, the cap first end having at least one flat area and a cap second end, the cap second end having a cap threaded connection where, when the apparatus is in a closed position, the cap second end is threadedly connected to the first end of the blender body and an o-ring, where, when the apparatus is in the closed position, the o-ring is fitted between the first end of the blender body and the cap second end.

In another aspect, embodiments disclosed herein relate to a system to prepare foam cement compositions in a laboratory, including an apparatus to prepare foam cement compositions in the laboratory, a first tubing assembly threaded to the inlet port, where the first tubing assembly is configured to receive at least one pressurized gas from a pressurized gas source and provide the at least one pressurized gas from the pressurized gas source to the apparatus, a second tubing assembly threaded to the test port, where the second tubing assembly includes a pressure gauge and a safety valve, and a motorized base.

In yet another aspect, embodiments disclosed herein relate to a method for preparing a foam cement composition using the apparatus for preparing foam cement compositions in a laboratory. The method includes obtaining a pressurized foaming blender, obtaining a calibrated volume of the pressurized foaming blender by obtaining an empty mass of the pressurized foaming blender, filling the pressurized foaming blender with water, massing the pressurized foaming blender comprising water, calculating a mass of water in the pressurized foaming blender, and calculating a volume of water in the pressurized foaming blender, where the volume of water contained in the pressurized foaming blender is equal to the calibrated volume of the pressurized foaming blender. The method also includes adding liquid cement additives to a pre-mixing blender, mixing the liquid cement additives at a low mixing speed, and adding, while still mixing at the low mixing speed, a dry cement base, fitting a blender cap on the pre-mixing blender and mixing the liquid cement additives and the dry cement base at a high mixing speed to obtain a cement composition. The method further includes transferring the cement composition from the pre-mixing blender to the pressurized foaming blender, fitting a blender cap on the pressurized foaming blender, and mixing the cement composition at a high speed, providing, using an inlet port formed through a wall of the pressurized foaming blender, a pressurized gas and a surfactant to the cement composition to produce a foam cement composition, and obtaining, using an outlet port on the pressurized foaming blender, the foam cement composition.

Other aspects and advantages of the claimed subject matter will be apparent from the following description and the appended claims.

### BRIEF DESCRIPTION OF DRAWINGS

FIG. 1 is a Waring blender according to prior art.

FIG. 2A is an atmospheric foam blender according to prior art.

FIG. 2B illustrates components of an atmospheric foam blender according to prior art.

FIG. 3A is a pressurized foam blender in accordance with one or more embodiments.

FIG. 3B illustrates a blender cap apparatus for a pressurized foam blender in accordance with one or more embodiments.

FIG. 3C illustrates a blender blade apparatus for a pressurized foam blender in accordance with one or more embodiments.

FIG. 4A is a system according to one or more embodiments.

FIG. 4B is an engineering cross section of a system according to one or more embodiments.

FIG. 5 is a flowchart for a method in accordance with one or more embodiments disclosed herein.

### DETAILED DESCRIPTION

Embodiments disclosed herein generally relate to systems and methods for improved foam cement testing and thus also improved foam cementing jobs.

Well cementing jobs typically include a primary cementing operation, in which first field specifications are rendered for the well which is being cemented, then a cement formulation is developed, and finally the cement formulation is pumped through the well to form a cement wall lining the wellbore wall. Pumping cement through a well typically includes pumping the cement through the center of a casing positioned in the well, and as the cement reaches the bottom of the well, the cement transitions up the annular space between the casing and the wellbore wall to line the wellbore wall. The cementing process continues at different intervals (stages) of the well for zonal isolation, which costs extra time and money.

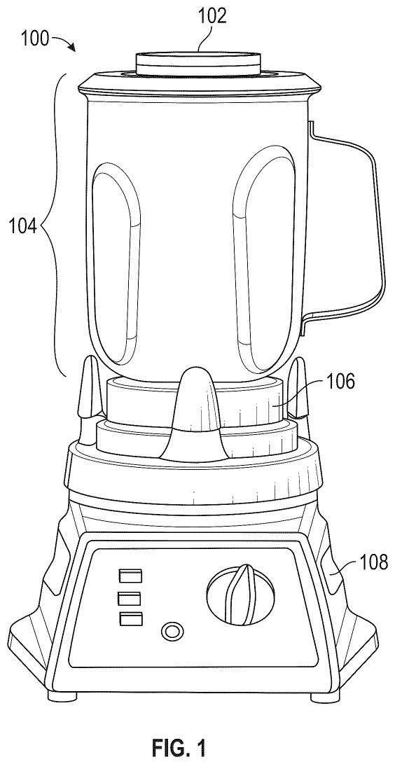

Primary cement formulations are evaluated in a laboratory prior to using the cement formulation in a cementing job. When testing foam cements in the laboratory, a standardized testing procedure is followed according to API (American Petroleum Institute) Recommended Practice 10B-2 and 10B-4 requirements, which include making the foam cement in blenders under atmospheric pressure. Conventional blenders used to prepare foam cement slurries in the laboratory include the Waring blender, as shown in FIG. 1, for mixing a base cement mixture, and an atmospheric foaming blender for foaming the base cement mixture.

As shown in FIG. 1, the Waring blender 100 includes a blender body 104 having a central volume where a cement composition is mixed. A blender blade (not pictured) inside the blender body 104 ensures adequate mixing of the cement composition. The blender body 104 also includes a base connector 106 which interlocks to a motorized base 108, where the motorized base 108 provides power to rotate the blender blade (not pictured) and mix the cement composition. The Waring blender is generally non-pressurized and may be used to pre-mix a cement composition prior to foaming.

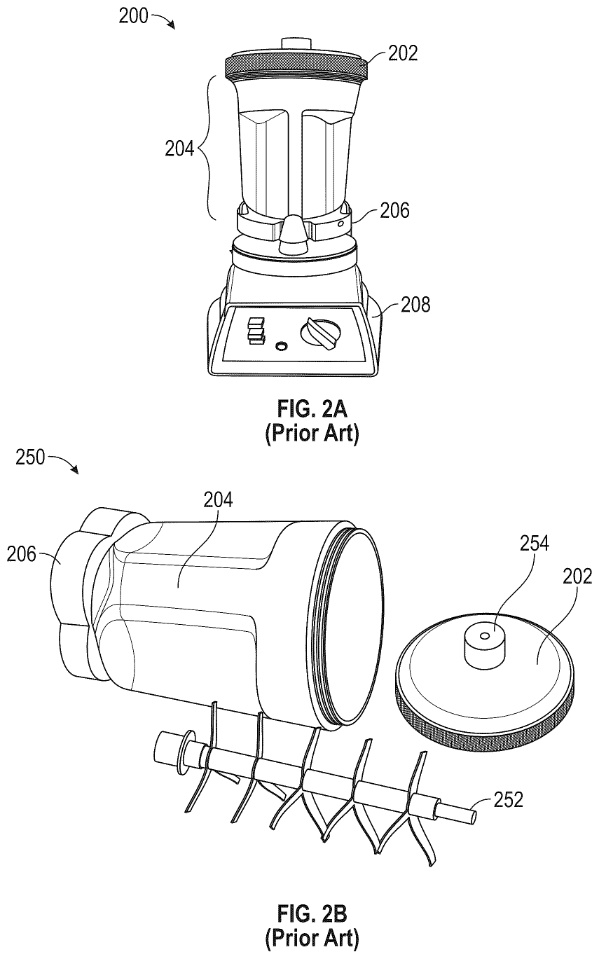

The standard type of atmospheric foaming blender according to API recommendations for laboratory testing is shown in FIGS. 2A-2B, where FIG. 2A shows the assembled atmospheric foaming blender 200 and FIG. 2B shows the unassembled components of the blender 200. The conventional, atmospheric foaming blender 200 foams cement under atmospheric conditions with little to no pressure being generated when foaming. This method is not specific to any foaming method in the field; the atmospheric foaming blender 200 follows a standardized laboratory testing procedure according to API recommended practice 10B-2 and 10B-4 requirements. The atmospheric foaming blender 200 includes a blender body 204 having a central volume where a foam cement composition is mixed, and a base connector 206 on the blender body 204, which interlocks to a motorized base 208. The atmospheric foaming blender 200 also has a threaded cap 202 with an o-ring seal. A blender blade 252 inside the blender body 204 includes five multiple stacked blades attached to a central shaft and spaced equally along the shaft according to ISO (International Organization for Standardization) 10426-2:2003. The length of the five blades is 7.5 inches with a blade separation of 1.25 inch distance. The motorized base 208 shown in FIG. 2A provides power to the blender blade 252 which ensures adequate mixing of the foam cement composition. The atmospheric foaming blender 200 is part of the API Recommended Practice 10B-4/ISO 10426-4:2003 standards for laboratory testing of foam cement. The threaded cap 202 also has a small hole (0.75-inch diameter) in the center fitted with a removable plug and a vent hole 254. The volume of the atmospheric foaming blender 200 is 1 liter. The atmospheric foaming blender 200 is 8.5 inches in height with a 4-inch inner diameter.

Foam cementing utilizes foam cement slurries having densities below 11 ppg, giving a wide range of utilization. In preparation for a foam cementing operation, field specifications may be established. A base cement slurry may then be mixed with selected additives suitable for use in the determined field conditions (e.g., depending on field conditions such as formation density, formation porosity, temperature, pressure, and other formation characteristics around the to-be-cemented well). The foaming agent (surfactant) and the gas (e.g., nitrogen gas) may then be injected into the base cement slurry at a certain pressure to form a foam cement slurry. The foam cement slurry may be used to line a well by pumping the foam cement slurring into a casing (or other tubular lining) until it reaches a bottom of the casing and transitions up the annular space between the casing and the well wall. An engineer in the field or an application may be used to determine a method to use for foam cementing, selected from a constant gas rate method (where the density of the foam cement may vary while gas is injected at a constant rate) or a constant density rate method (where the gas injection rate is varied to maintain a constant density of the foam cement). The composition of a foam cement may be tested in a laboratory before being used in a foam cementing job in order to optimize performance of the foam cement in the wellbore and/or to help in determining which type of foam cementing method to select.

Conventional blenders that have been used in conventional foam cement testing operate under atmospheric pressure using the API recommended practices. Thus, these conventional methods are not suitable for accurately simulating the foam cement compositions in downhole conditions, where the pressure along a well can be varied along its length and significantly greater than surface or atmospheric pressure. For example, the downhole pressure in a well can range from a few hundred psi in shallow wells to several thousand psi in deeper wells.

To date there is no laboratory blender available commercially that can be used to prepare foam under non-atmospheric pressure (under API 10B-2 or 10B-4). However, embodiments disclosed herein include a pressurized foaming blender that allows cement to foam with nitrogen (and/or other gases) under downhole pressure ranges. For example, a pressurized foaming blender according to embodiments disclosed herein may subject a foam cement to pressurized testing simulating a constant gas method that is generated in the field. Using the pressurized foaming blender of one or more embodiments, a more accurate field simulation can be executed in the laboratory for proper field development. In addition to making foam cement slurry with nitrogen or air, embodiments disclosed herein also include a method for preparing CO₂ foam cement slurries with a pressurized foaming blender. In contrast to using conventional foam cementing blenders which foam cement under atmospheric conditions, pressurized foaming blenders according to embodiments disclosed herein are able to test foam cement in the laboratory under pressurized conditions (e.g., pressures equal to well pressure in a well-being cemented) to better mirror field conditions and improve accuracy. Accordingly, improved pressurized foaming blenders disclosed herein may be used to cement under high pressures in the laboratory, similar to the pressures experienced in real field operations.

### Pressurized Foaming Blender

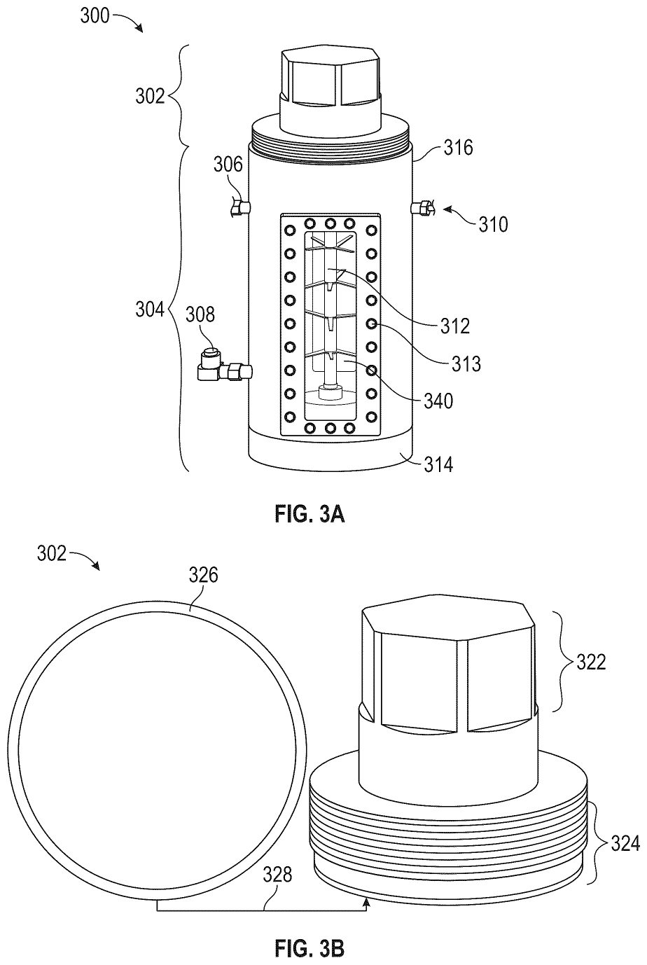

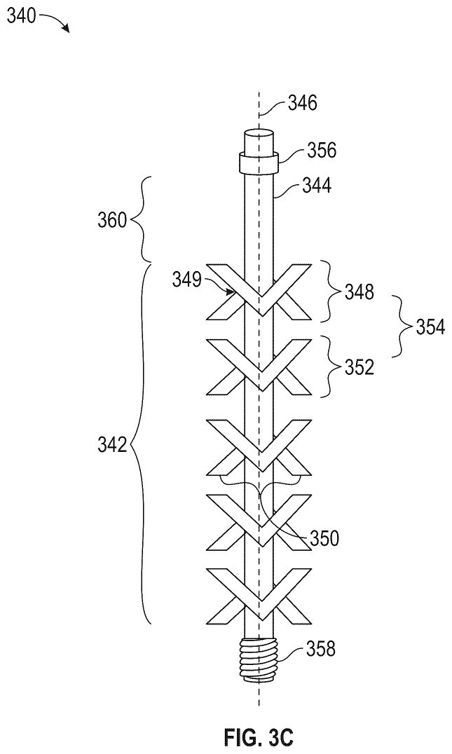

FIG. 3A shows a pressurized foaming blender according to one or more embodiments. The pressurized foaming blender 300 includes a blender body 304, a blender cap 302, and a blender blade apparatus (as shown in 340 of FIG. 3C). The pressurized foaming blender 300 is an apparatus that pressurizes gases in a contained environment during the blending process in a laboratory setting.

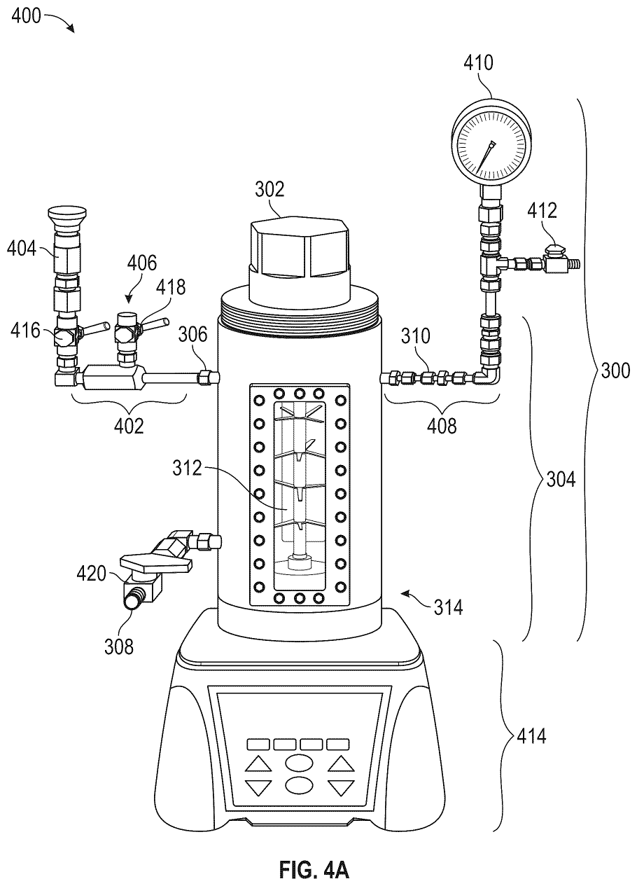

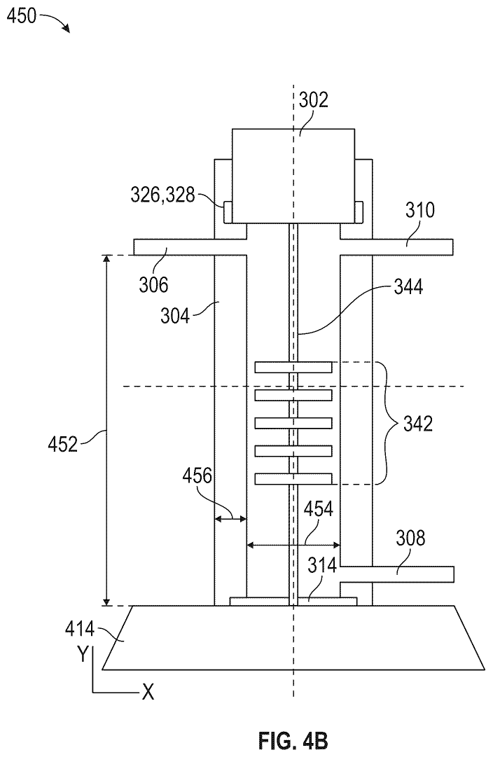

The blender body 304 of the pressurized foaming blender 300 has a blender body wall (as best shown in FIG. 4B, 456, and will be described with reference to FIG. 4B, below) which extends around a central volume of the blender body 304 and defines an inner diameter of the blender body 304. The blender body 304 also includes multiple ports to allow gas flow into/out of the blender body 304 and pressure monitoring. In the embodiment shown, the blender body 304 includes a test port 310, an inlet port 306, and an outlet port 308 formed through the blender body wall, where the inlet port 306 and the outlet port 308 may be connected to an external tubing apparatus, as will be described in more detail in FIG. 4A. At least one view port 312 is integrated into the blender body 304 by a plurality of screws 313 disposed about the perimeter of the view port, which allows visual observation of cement foaming during laboratory testing. A gasket is also included between the perimeter of the view port 312 and the blender body wall. The screws 313 may extend through the perimeter of the view port and the gasket into the blender body wall to ensure pressure is maintained in the blender.

In one or more embodiments, the central volume of the blender body may receive a cement composition to be foamed in a laboratory. The central volume of the blender body represents a maximum total volume of the cement composition after foaming. The central volume of the blender body according to one or more embodiments may have a volume in a range having a lower limit of from about 1,000 mL to an upper limit of about 1,200 mL, such as a lower limit of 1,000 mL and 1,050 mL to an upper limit of 1,100 mL and 1,200 mL, where any lower limit may be paired with any mathematically compatible upper limit.

In one or more embodiments, at least one view port in the blender body may include two view ports located on opposite sides of the blender body such that foaming of the cement composition may be observed from either side of the blender. A view port may be made of a material and have a thickness capable of withstanding high pressures generated during testing. In one or more embodiments, the view port has a thickness of at least 1 inch. As non-limiting examples, the thickness of the view port may be 1 inch, 2 inches, or 3 inches. In one or more embodiments, the view port may be constructed of a material selected from the group consisting of glass, polymers, copolymers, or the like. Examples of polymers and copolymers suitable for view port construction include, but are not limited to, polycarbonate, polypropylene, impact copolymer polypropylene.

The blender body 304 of FIG. 3A also includes a first end having a threaded connection 316 and a second end having a base connector 314. The first end having a threaded connection 316 is configured to threadedly connect to a blender cap 302, which is shown in more detail in FIG. 3B. The blender cap 302 includes a cap second end 324 which, when the apparatus 300 is in a closed position, is threaded to the first end having a threaded connection 316 of the blender body 304. In the embodiment shown, the cap second end 324 has threads formed around its outer surface, which mates with threads formed around an inner surface of the blender body first end, such that the blender cap 302 is inserted and threaded into the first end. In other configurations, a blender cap and blender body threaded connection may be oppositely arranged to have inner threads in the blender cap fit and thread around outer threads formed around the blender body. An o-ring 326 is also fitted in a location 328 between the first end of the blender body having a threaded connection 316 and the cap second end 324 when the pressurized foaming blender 300 is in the closed position. The blender cap 302 further includes a cap first end with at least one flat area providing a torquing feature 322. The torquing feature 322 may be sized to fit a wrench or other torquing tool configured to lock onto and torque the torquing feature 322 to thread or unthread the blender cap 302 from the blender body 304 before or after foaming a cement slurry in a laboratory. In one or more embodiments, the cap may be tightened or loosened by hand or using a wrench or other tool.

According to one or more embodiments, the o-ring may be made of a material selected from the group consisting of nitrile, hydrogenated nitrile, silicone rubber, polyacrylate, ethylene propylene rubber, neoprene, fluorocarbon, and Teflon, or the like.

FIG. 3C shows a blender blade apparatus 340 in accordance with one or more embodiments disclosed herein. The blender blade apparatus 340 includes a central shaft 344 with a first axial end 356 and an opposite, second axial end having a threaded portion 358. A multi-blade assembly 342 is provided along the central shaft 344. The central shaft 344 may be provided within the central volume of the blender body, as shown in FIG. 3A, and threadedly connected to the blender body 304 at the threaded portion of the second axial end 358.

In one or more embodiments, the blender blade apparatus 340 includes a multi-blade assembly 342 made of a plurality of blade assemblies, for example, a first blade assembly 348 and a second blade assembly 352. The multi-blade assembly 342 includes one or more blade assemblies positioned at an axial location along the central shaft 344, beginning at a location having a distance 360 from the first axial end 356 of the central shaft 344. Each blade assembly includes at least one blade 349, typically a plurality of blades, extending radially outward in multiple directions from the central shaft 344. Each blade assembly occupies a space defined by a blade diameter 350. The plurality of blade assemblies is distributed axially along a central shaft axis 346 of the central shaft 344. Neighboring blade assemblies in the plurality of blade assemblies, such as the first blade assembly 348 and the second blade assembly 352, are separated by a blade separation distance 354.

The blade separation distance according to one or more embodiments may be the same between neighboring blade assemblies or different. In a specific embodiment, the multi-blade assembly may include five blade assemblies axially distributed along the central axis and having an equal blade separation distance between each set of neighboring blade assemblies (e.g., where the length of the five blades stands 10¾″ in length and an equal blade separation of 1½″ is provided between each set of neighboring blade assemblies, as outlined in ISO 10426-2:2003).

FIG. 4A shows a system for preparing foam cement compositions in a laboratory according to one or more embodiments. The system 400 of FIG. 4A includes the pressurized foaming blender 300 to prepare foam cement compositions of FIG. 3A, which includes the blender body 304, having a first end with a threaded connection, a second end with a base connector, at least one view port 312, an inlet port 306, a test port 310, and an outlet port 308. The apparatus further includes the blender cap 302 and the blender blade apparatus 340, as described in preceding paragraphs.

The system 400 of FIG. 4A also includes a first tubing assembly 402 threaded to the inlet port 306. The first tubing assembly 402 is configured to receive at least one pressurized gas from a pressurized gas source 404 and provide the at least one pressurized gas from the pressurized gas source 404 to the apparatus 300 via the inlet port 306. One or more embodiments disclosed herein includes a second pressurized gas source 406 which is also tubularly connected to the first tubing assembly 402 as shown in FIG. 4A. The pressurized gas may be added to the apparatus 300 using a first valve 416 and the second pressurized gas may be added using a second valve 418. In some embodiments, an additional pressurized gas source or sources may enter the apparatus 300 at an additional inlet port or ports (not pictured). An outlet port 308 allows for the foam cement to be retrieved after mixing in the pressurized foaming blender. The outlet port may contain an outlet valve 420 to control the flow of foam cement exiting the pressurized foaming blender.

In one or more embodiments, the pressurized foaming blending may receive a pressurized gas selected from the group consisting of nitrogen, air, carbon dioxide, and combinations therein. When the apparatus is in the closed position, it may receive at least one pressurized gas having a total pressure of 1000 psi or less.

The first valve 416 and the second valve 418 of one or more embodiments may be any suitable valve known in the art capable of controlling the flow of a gas. For example, the first valve and the second valve may be a gate valve, a globe valve, a check valve, a plug valve, a ball valve, a butterfly valve, a slam-shut valve, or the like.

The outlet valve 420 of one or more embodiments may be any suitable valve known in the art capable of controlling a fluid, such as a foam cement. For example, the outlet valve may be a gate valve, a globe valve, a check valve, a plug valve, a ball valve, a butterfly valve, a pressure relief valve, or the like.

The system 400 of FIG. 4A also includes a second tubing assembly 408 threaded to the test port 310. The second tubing assembly 408 may connect to a pressure gauge 410 configured to measure a pressure of the blender volume and a safety valve 412 configured to release pressure when a maximum pressure is exceeded.

In some embodiments, the test port 310, the inlet port 306, and the outlet port 308 may include more than one of each port formed through the blender body wall. For example, the blender body 304 may include a single test port 310 or may include one or more additional test ports configured to receive one or more additional measurement instruments, for example, a temperature gauge, a second pressure gauge, or the like. The blender body may also include a single inlet port or may include multiple inlet ports configured to receive, for example, one or more pressurized gas sources, a liquid (for example, a surfactant), or the like. Additionally, the blender body may have a single outlet port or may include multiple outlet ports. In one or more embodiments, the outlet port may dispense a foam cement composition after foaming.

Keeping with FIG. 4A, the system 400 further includes a motorized base 414. The motorized base is configured to provide power to the pressurized foaming blender 300 when the second end of the blender body 304 having the base connector 314 is interlocked into the motorized base. In one or more embodiments, the motorized base may be an API certified blender base including, but not limited to, a Waring Constant speed mixer, a Fann constant speed mixer, or similar devices.

FIG. 4B is an engineering cross section of a pressurized foaming blender system according to one or more embodiments. The system 450 of FIG. 4B includes the motorized base 414, the blender body 304 as described previously, having a blender height 452 and a blender body wall having a thickness 456. The blender body 304 also includes a first end with a threaded connection, a second end with a base connector 314, at least one view port 312, an inlet port 306, a test port 310, and an outlet port 308. The pressurized foaming blender further includes the blender cap 302 and the blender blade apparatus 340, as described in preceding paragraphs.

The blender cap 302 is threaded to the first end of the blender body 304 having a threaded connection, as previously described, when the pressurized foaming blender is in the closed position. FIG. 4B demonstrates sealing of the blender cap 302 by an o-ring 326 having an o-ring location 328 between an outer surface of the blender cap 302 and an inner surface of the blender body 304, as shown.

Notably, the blender body 304 has an inner diameter 454, as shown in FIG. 4B. When the central shaft 344 of the blender blade apparatus (340 in FIG. 3C) is provided within the central volume of the blender body 304 and threadedly connected to the blender body 304 at the threaded portion of the second axial end (358 in FIG. 3C), the multi-blade assembly 342 occupies a radial space of the blender body inner diameter 454 defined by the blade diameter (350 in FIG. 3C).

In one or more embodiments, the blender body wall may have a thickness 456 capable of safely containing a highly pressurized foam cement slurry. For example, the blender body wall may have a thickness in a range having a lower limit of from about 0.8 inches to an upper limit of about 1.2 inches, such as a lower limit of 0.80, 0.85, and 0.90 inches to an upper limit of 0.95, 1.0, 1.1, and 1.2 inches, where any lower limit may be paired with any mathematically compatible upper limit.

In one or more embodiments, the height 452 of the blender body may be about 14 inches to about 19 inches. The blender body may have a height in a range having a lower limit of about 14, 14.5, and 15 inches to an upper limit of about 16, 17, and 19 inches, where any lower limit may be paired with any upper limit.

In one or more embodiments, the inner diameter 454 of the blender body may be about 1.5 inches to about 3.0 inches. The blender body may have an inner diameter in a range having a lower limit of about 1.5, 2.0, and 2.25 inches to an upper limit of about 2.5, 2.75, and 3.0 inches, where any lower limit may be paired with any upper limit.

The blade diameter (e.g., 350 in FIG. 3C) of one or more embodiments is designed to ensure adequate mixing of a foam cement composition. The blade diameter according to one or more embodiments may occupy a space in the inner diameter of the blender body in a range having a lower limit of from about 65% to an upper limit of about 90%, such as a lower limit of 65%, 70%, and 75% to an upper limit of 80%, 85% and 90%, where any lower limit may be paired with any mathematically compatible upper limit.

### Methods for Preparing a Pressurized Foam Cement Slurry

In embodiments disclosed herein, it is desirable to prepare foam cement slurries under pressure in laboratory tests to confirm the stability of foam cement under downhole conditions. An unstable foam cement slurry pumped downhole can cause severe and even catastrophic incidents due to wellbore pressure control issues. Currently, there is no laboratory blender available commercially that can be used to prepare foam under pressure using API Recommended Practice 10B. Pressurized foaming blenders disclosed herein foam a cement composition with nitrogen or other gases under pressure (e.g., high pressures corresponding to downhole pressures), and may apply pressure according to a method similar to the “constant gas method” that is performed in the field. Therefore, performing laboratory foam cement testing using a pressurized foaming blender according to one or more embodiments provides a more accurate field simulation to be executed in the laboratory prior to a cementing field job for proper field development.

In general, foam cement may be provided to a well during foam operations using two main methods. The first method, often referred to as the “constant density” method, includes increasing gas (e.g., nitrogen) flow rate based on a calculated hydrostatic pressure in the well as a cement slurry is pumped into a well, thus creating a foam cement composition with constant density throughout the length of the well. On the other hand, the variable foam density method, also known as the constant gas (e.g., nitrogen) method, provides a constant gas flow rate based on a calculated maximum average density of a foam cement composition combined with the weight of additional downhole fluids, such that the combined force does not exceed an anticipated fracture gradient in the well. Therefore, the foam cement composition pumped downhole will have varying densities throughout the length of the well. The pressurized foaming blender apparatus of one or more embodiments has the capability of simulating actual well conditions using the constant gas rate method (variable foam density). In some embodiments, a pressurized foaming blender according to embodiments of the present disclosure may be used to perform multiple foam cement tests at multiple different pressures (e.g., representative of varying hydrostatic pressures in a well), where the foam cement is designed to have a substantially uniform foam density at each of the different pressures in order to simulate the foam cement performance in a well cemented using a constant density method. Thus, the development of this technology may perform a more accurate laboratory standard for proper field assessment.

Embodiments disclosed herein relate to a method for preparing a foam cement composition in a laboratory using a pressurized foaming blender in accordance with one or more embodiments. The method described herein generally follows standard testing procedures are followed using API Recommended Practice 10B-2 and 10B-4 using the pressurized foaming blender.

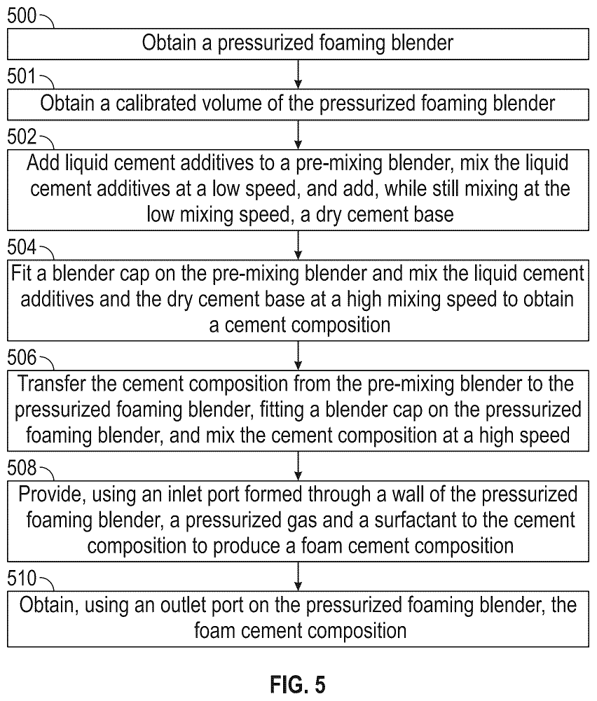

FIG. 5 is a flowchart of a method according to embodiments of the present disclosure for preparing a foam cement composition. In one or more embodiments, the method for preparing a foam cement composition includes, in step 500, obtaining a pressurized foaming blender. In step 501, the method further includes obtaining a calibrated volume of a pressurized foaming blender. In one or more embodiments, the calibrated volume of the pressurized foaming blender may be determined by measuring an empty mass of the pressurized foaming blender, filling the pressurized foaming blender with water, massing the pressurized foaming blender comprising water, calculating a mass of water in the pressurized foaming blender, and calculating a volume of water in the pressurized foaming blender using the density of water.

In step 502 of FIG. 5, the method further includes adding liquid cement additives to a pre-mixing blender, mixing the liquid cement additives at a low speed, and adding, while still mixing at the low mixing speed, a dry cement base.

In some embodiments, the dry cement base is pre-mixed in a closed container prior to adding the dry cement base to the pre-mixing blender. The dry cement base of one or more embodiments may include, as the cement base, Portland cement (also known as API Oilwell Cement), API class A, B, C, G, or H cements, Saudi cement, Ordinary Cement Type I, II, III, IV, or V, or other cement bases known in the art, and dry additives such as thickeners (for example, hydroxyethyl cellulose), densifiers, accelerators, retardants, strengthening additives, and other additives known in the art. The amount of dry cement base will vary depending on the desired cement composition, as will be understood by one of ordinary skill in the art.

In one or more embodiments, the liquid cement additives may include water, foaming additives, defoaming additives, liquid latex, liquid stabilizers, dispersants, retarders, fluid loss additives, viscosifiers, and any of the additives described in the dry cement base in liquid form. The amount of liquid additives added to produce the cement composition will vary depending on the desired cement composition, as will be understood by one of ordinary skill in the art.

The pre-mixing blender of one or more embodiments may be a Waring blender, or a similar blender known in the art.

In one or more embodiments, the low mixing speed of the pre-mixing blender may be about 2,000 rpm to about 6,000 rpm. For example, the low mixing speed of the pre-mixing blender may be in a range having a lower limit of about 2,000, 2,500, and 3,000 rpm to an upper limit of about 4,000, 5,000, and 6,000 rpm, where any lower limit may be paired with any upper limit.

In step 504 of FIG. 5, the method also includes fitting a blender cap on the pre-mixing blender and mixing the liquid cement additives and the dry cement base at a high mixing speed to obtain a cement composition.

In one or more embodiments, the high mixing speed of the pre-mixing blender may be about 9,000 rpm to about 15,000 rpm. For example, the high mixing speed of the pre-mixing blender may be in a range having a lower limit of about 9,000, 10,000, and 11,000 rpm to an upper limit of about 12,000, 14,000, and 15,000 rpm, where any lower limit may be paired with any upper limit.

In some embodiments, the pre-mixing blender may be operated at the high mixing speed for at least 35 seconds. For example, the pre-mixing blender may be operated at the high mixing speed for 35 seconds, 60 seconds, 90 seconds, 120 seconds, or 180 seconds. In one or more embodiments, mixing speeds and durations may follow API recommended practice 10B-2.

In step 506 of FIG. 5, the method further includes transferring the cement composition from the pre-mixing blender to the pressurized foaming blender of one or more embodiments, fitting a blender cap on the pressurized foaming blender, and mixing the cement composition at a high speed.

The pressurized foaming blender of one or more embodiments may operate at a high speed as described for the pre-mixing blender, above. The pressurized foaming blender may operate at the high mixing speed for a duration of at least 15 seconds. For example, the pressurized foaming blender may be operated at the high mixing speed for a duration of 15 seconds, 30 seconds, 60 seconds, or 90 seconds.

In step 508 of FIG. 5, the method further includes providing, using an inlet port formed through a wall of the pressurized foaming blender, a pressurized gas, and a surfactant to the cement composition to produce a foam cement composition. In some embodiments, the method includes adding the surfactant to the cement slurry before mixing, e.g., adding the surfactant on top of the cement slurry after the cement slurry has been poured inside the blender. The pressurized gas may be provided to the pressurized foaming blender before or during mixing. For example, in one or more embodiments, gas may be injected into the pressurized foaming blender from a fluidly connected gas source until a selected pressure is reached, where once the selected pressure is reached, one or more valves may close gas communication and then the mixing may commence. In some embodiments, gas may be injected into the pressurized foaming blender from a fluidly connected gas source until a selected pressure is reached, and then mixing may commence while the gas pressure is maintained within the blender (e.g., using one or more valves to control gas flow into/out of the blender during mixing). In such embodiments, the pressurized gas may be provided to the pressurized foaming blender while mixing. In some embodiments, the method includes mixing the surfactant and the cement composition and providing the pressurized gas to the pressurized foaming blender.

In one or more embodiments, the surfactant may be an ethoxylate having about 12 to about 16 carbon atoms, glycerol, or any other surfactant known in the art. The amount of surfactant added to produce the foam cement composition will vary depending on the desired foam cement density, as will be understood by one of ordinary skill in the art.

The pressurized gas added to the foam cement composition may be any of the pressurized gases described in previous sections. The pressure of the pressurized gas may be less than 1000 psi, as described in previous sections. The amount of pressurized gas added to produce the foam cement composition will vary depending on the desired foam cement density, as will be understood by one of ordinary skill in the art. For example, a relatively higher amount of gas (by percent volume of the composition) may be used to provide a relatively lower foam cement density compared with a foam cement foamed with a relatively lower amount of gas.

In step 510 of FIG. 5, the method further includes obtaining, using an outlet port on the pressurized foaming blender, the foam cement composition.

Upon obtaining the foam cement composition, the foam cement composition may be tested by any foam cement test methods known in the art, including, but not limited to, the BP settling method, rheological testing, fluid loss testing, (pressure containing) curing cells, and static and dynamic compressive strength testing to test the strength and performance of the produced foam cement.

### EXAMPLES

### Example 1

Example 1 illustrates laboratory testing performed using a pressurized foaming blender, according to one or more embodiments disclosed herein. Prior to preparation of example 1, an accurate calibrated volume of the blender is first provided. The pressurized foaming blender, the cap, and screw in plug are weighed. After the blending assembly is weighed, water is filled to the top of the pressurized foaming blender, with the lid screwed on tightly. Additional water is poured into the hole at the top of the lid, then the screw in plug is threaded on top of the lid. The excess water is wiped off the plug's vent hole on the lid then the pressurized foaming blender is re-weighed. The mass of water inside the container is then divided by the density of water to determine an accurate volume for the blending container.

In example 1, a base cement was prepared using Saudi G cement, HEC Hydroxyethyl cellulose (HEC), and water, as shown in Table 1, below. As used herein, “% BWOC” is defined as percent base weight of cement. To prepare the base cement, 785.92 grams of Saudi G Cement, 3.93 grams of HEC, and 346.84 ml of water were mixed in a 1-liter Waring blender (pre-mixing blender). The initial density of the cement was calculated to be 15.8 ppg. The liquid content is added to the Waring blender first, then the blender is switched on to 4,000 rpm. The dry composition is added to the liquid while the blender is mixing. Once the dry content is completely placed in the blender, the blender is switched to 12,000 rpm for 35 seconds.

After the base cement is mixed in the Waring Blender, the base cement is then poured into the pressurized foaming blender according to one or more embodiments disclosed herein. To foam the cement slurry, 13.95 grams (0.2 GPS (gallons per sack)) of foaming agent (surfactant) is added on top of the base cement to the pressurized foaming blender. Once the cap is screwed on the pressurized foaming blender, 50 psi of CO₂ gas pressure is applied to the central volume of the pressurized foaming blender at 42 vol % compared to the total volume of the cement slurry, the pressurized foaming blender is switched to 12,000 rpm for 15 seconds according to API recommended practice 10B-2 to produce foam cement. Foaming of example 1 was observed using the polycarbonate window which is integrated into the pressurized foaming blender. CO₂ gas was injected into the cement under pressure with surfactant simultaneously to generate foam, according to the “constant gas rate method” of foam cementing. After the foaming process, the density of the foam cement was reduced to 9 ppg.

The foam cement was poured into a 1 inch by 8 inch mold with caps on each end and cured for 24 hours. The sample weight, submersed weight, specific gravity, and density of the foam cement for example 1 as determined from the BP Settling Test after foaming are reported in Table 1. As would be appreciated by one of ordinary skill in the art, the BP Settling Test is used to test the settling characteristics of a well cement. The cement slurry is poured into a tube and cured in a Consistometer or a water bath. After the cement has fully cured, the cement column is cut from the tube into pieces and the density of each piece is measured using Archimedes Principle. Measured density of the samples shown in Table 1 were slightly higher than calculated after foaming. Obtaining a slightly different final density of the foam cement slurry compared to the theoretical calculated value is a common occurrence and can be adjusted by using a correction factor for future calculations according to API Recommended Practice 10B-4 (section 7.2 Generation of a foam cement slurry).

TABLE 1
Example 1-Cement Composition (foamed with 42 vol % CO₂)

| | | | | Foaming | Density |
|---|---|---|---|---|---|
| Name | Saudi G | HEC | Water | Agent | (ppg) |
| (%) | 100 | 0.5 | 0.44 | | |
| BWOC | | | | | |
| GPS | | | | 0.2 | 15.8 |

Example 1 Results-BP Settling Test (After foaming)

| | Sample | Submersed | Specific | Density |
|---|---|---|---|---|
| (Top) | weight | weight | gravity | (ppg) |
| 1 | 11.78 | 10.42 | 1.13 | 9.42 |
| 2 | 10.25 | 9.39 | 1.09 | 9.10 |
| 3 | 9.74 | 8.92 | 1.09 | 9.09 |
| 4 | 9.36 | 8.58 | 1.09 | 9.10 |
| 5 | 10.08 | 9.25 | 1.09 | 9.09 |
| 6 | 8.98 | 8.23 | 1.09 | 9.10 |
| 7 | 9.35 | 8.60 | 1.09 | 9.09 |
| (Bottom) | | | | |

### Example 2

Example 2 also illustrates laboratory testing performed using a pressurized foaming blender, according to one or more embodiments disclosed herein.

In example 2, a base cement was prepared using Saudi G cement, HEC, and water, as shown in Table 2, below. The initial density of the cement was calculated to be 15.8 ppg. To prepare the base cement, 785.92 grams of Saudi G Cement, 3.93 grams of HEC, and 346.84 ml of water are mixed in a 1-liter Waring Blender (pre-mixing blender). The liquid content is added to the pre-mixing blender and blended at 4,000 rpm. The dry composition is then added to the liquid while the pre-mixing blender is mixing. Once the dry content is completely placed in the pre-mixing blender, the blender is switched to 12,000 rpm for 35 seconds.

After the base cement is mixed in the Waring Blender, the base cement is poured into the pressurized foaming blender according to one or more embodiments disclosed herein. To foam the cement slurry, 13.95 grams of foaming agent (surfactant) is added on top of the base cement in the pressurized foaming blender. Once the cap is screwed on the pressurized foaming blender, 50 psi of CO₂ gas pressure is applied to the central volume of the pressurized foaming blender at 21 vol % compared to the total volume of the cement slurry, and the pressurized foaming blender is switched to 12,000 rpm for 15 seconds according to API recommended practice 10B-2. Foaming of example 2 was observed using the polycarbonate window which is integrated into the pressurized foaming blender. CO₂ gas was injected into the cement under pressure with surfactant simultaneously to generate foam, according to the “constant gas rate method” of foam cementing. After foaming, the density of the cement was reduced to 12 ppg.

The pressurized foam cement according to example 2 was poured into a 1 inch by 8 inch mold with caps on each end and cured for 24 hours. The sample weight, submersed weight, specific gravity, and density of the foam cement for example 2 as determined from the BP Settling Test after foaming are reported in Table 2. As mentioned above, measured density of the samples shown in Table 2 were also slightly higher than calculated after foaming. Obtaining a slightly different final density of the foam cement slurry compared to the theoretical calculated value is a common occurrence and can be adjusted by using a correction factor for future calculations according to API Recommended Practice 10B-4 (section 7.2 Generation of a foam cement slurry).

TABLE 2
Example 2-Cement Composition (foamed with 21 vol % CO₂)

| | | | | Foaming | Density |
|---|---|---|---|---|---|
| Name | Saudi G | HEC | Water | Agent | (ppg) |
| (%) | 100 | 0.5 | 0.44 | | |
| BWOC | | | | | |
| GPS | | | | 0.2 | 15.8 |

Example 2 Results-BP Settling Test (After foaming)

| | Sample | Submersed | Specific | Density |
|---|---|---|---|---|
| (Top) | weight | weight | gravity | (ppg) |
| 1 | 12.22 | 8.24 | 1.48 | 12.3 |
| 2 | 16.84 | 11.35 | 1.48 | 12.3 |
| 3 | 12.31 | 8.20 | 1.50 | 12.5 |
| 4 | 13.50 | 9.00 | 1.50 | 12.5 |
| 5 | 20.05 | 13.34 | 1.50 | 12.5 |
| 6 | 19.75 | 13.16 | 1.50 | 12.5 |
| 7 | 19.40 | 12.34 | 1.57 | 13.0 |
| (Bottom) | | | | |

Example 1 reduced the base cement density from 15.7 to about 9 ppg, whereas Example 2 reduced the base cement density from 15.8 ppg to about 12 ppg, as shown in Table 1 and Table 2, respectively. In Example 2, the 15.8 ppg cement slurry was lowered to 12.0 ppg by using an extender (water, glass beads, fly ash, or bentonite etc.). Once the cement design reached a density of 12.0 ppg, the 12.0 ppg cement slurry was then foamed to 9.00 ppg. In addition, the BP settling data demonstrate the foam quality was reasonably uniform from top to bottom of the cured cylindrical specimen.

Tables 1 and 2 provide two examples of a low dense Foam Cement system, the Pressurized Foam Blender can accommodate, where a Class G base cement with a density of 15.8 ppg is used (Cement density). Lowering the cement density depends on the softness of the rock in an oil and gas well. If the rock is too soft a cement with a density of 15.8 ppg will induce force on the rock causing it to crack prematurely. A low dense cement (Foam Cement) will support the soft rock (low dense rock formation) without cracking the rock. Cement may be used in an oil and gas well to stabilize the well before production, and not to induce a fracture in the formation before isolating the zones. Tables 1 and 2 have the same base cement composition but use different amounts of gas (CO₂) in order to achieve a different foamed density, i.e., 9 ppg and 12 ppg density. The calculations are based on the total volume of the blender including the internal blade assembly. In case the volume of the blender changes over time due to excessive use (i.e., wear and tear on the blades), the volume may be checked and calibrated periodically for consistency in the calculations. By using the pressurized foaming blender according to embodiments of the present disclosure, a more accurate field simulation can be executed in the laboratory for proper field development.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. An apparatus for preparing foam cement compositions in a laboratory, comprising:
a blender body, comprising;
a blender body wall extending around a central volume and defining an inner diameter of the blender body;
a first end comprising a threaded connection;
a second end comprising a base connector;
an inlet port formed through the blender body wall;
a test port; and
an outlet port formed through the blender body wall;
a blender blade apparatus, comprising:
a central shaft comprising a first axial end and a second axial end having a threaded portion; and
a multi-blade assembly provided along the central shaft,
wherein the central shaft is provided within the central volume of the blender body and threadedly connected to the blender body at the threaded portion;
a blender cap, comprising:
a cap first end, the cap first end comprising at least one flat area; and
a cap second end, the cap second end comprising a cap threaded connection wherein, when the apparatus is in a closed position, the cap second end is threadedly connected to the first end of the blender body; and
an o-ring, wherein, when the apparatus is in the closed position, the o-ring is fitted between the first end of the blender body and the cap second end.

2. The apparatus of claim 1, wherein the central volume ranges from 1,000 mL to 1,200 mL.

3. The apparatus of claim 1, wherein the blender body wall has a thickness ranging from 0.8 to 1.2 inches.

4. The apparatus of claim 1, wherein the blender body further comprises a view port connected to the blender body wall, the view port having a thickness of at least 1 inch.

5. The apparatus of claim 4, wherein the view port comprises polycarbonate.

6. The apparatus of claim 4, wherein a gasket is provided between the view port and the blender body wall.

7. The apparatus of claim 1, wherein the multi-blade assembly comprises a plurality of blade assemblies, each blade assembly comprising at least one blade and having a blade diameter, wherein:
the plurality of blade assemblies is distributed axially along the central shaft; and
neighboring blade assemblies of the plurality of blade assemblies are separated by a blade separation distance.

8. The apparatus of claim 7, wherein the blade diameter ranges from 65% to 90% of the inner diameter of the blender body.

9. The apparatus of claim 1, wherein the multi-blade assembly comprises five blade assemblies.

10. The apparatus of claim 1, wherein the multi-blade assembly comprises a blade assembly positioned at an axial location along the central shaft, wherein the blade assembly comprises a plurality of blades extending radially outward in multiple directions from the central shaft.

11. A system to prepare foam cement compositions in a laboratory, comprising:
an apparatus to prepare foam cement compositions in the laboratory, comprising;
a blender body, comprising,
a blender body wall extending around a central volume and defining an inner diameter of the blender body;
a first end comprising a threaded connection;
a second end comprising a base connector;
an inlet port formed through the blender body wall;
a test port; and
an outlet port formed through the blender body wall;
a blender blade apparatus, comprising,
a central shaft comprising a first axial end and a second axial end having a threaded portion; and
a multi-blade assembly provided along the central shaft, wherein the central shaft is provided within the central volume of the blender body and threadedly connected to the blender body at the threaded portion;
a blender cap, comprising:
a cap first end, the cap first end comprising at least one flat area;
a cap second end, the cap second end comprising a cap threaded connection wherein, when the apparatus is in a closed position, the cap second end is threadedly connected to the first end of the blender body; and
an o-ring, wherein, when the apparatus is in the closed position, the o-ring is fitted between the first end of the blender body and the cap second end;
a first tubing assembly threaded to the inlet port, wherein the first tubing assembly is configured to receive at least one pressurized gas from a pressurized gas source and provide the at least one pressurized gas from the pressurized gas source to the apparatus;
a second tubing assembly threaded to the test port, wherein the second tubing assembly comprises a pressure gauge and a safety valve; and
a motorized base.

12. The system of claim 11, wherein the motorized base is configured to provide power to the apparatus when the second end of the blender body comprising the base connector is interlocked into the motorized base.

13. The system of claim 11, wherein the at least one pressurized gas comprises nitrogen, air, carbon dioxide combinations therein.

14. The system of claim 11, wherein, when the apparatus is in the closed position, the pressurized gas source is configured to provide 1000 psi or less of the at least one pressurized gas.

15. A method for preparing a foam cement composition using the apparatus for preparing foam cement compositions in a laboratory of claim 1, comprising:
obtaining a pressurized foaming blender;
obtaining a calibrated volume of the pressurized foaming blender by obtaining an empty mass of the pressurized foaming blender, filling the pressurized foaming blender with water, massing the pressurized foaming blender comprising water, calculating a mass of water in the pressurized foaming blender, and calculating a volume of water in the pressurized foaming blender, wherein the volume of water contained in the pressurized foaming blender is equal to the calibrated volume of the pressurized foaming blender;
adding liquid cement additives to a pre-mixing blender, mixing the liquid cement additives at a low mixing speed, and adding, while still mixing at the low mixing speed, a dry cement base;
fitting a blender cap on the pre-mixing blender and mixing the liquid cement additives and the dry cement base at a high mixing speed to obtain a cement composition;
transferring the cement composition from the pre-mixing blender to the pressurized foaming blender, fitting a blender cap on the pressurized foaming blender, and mixing the cement composition at a high speed;
providing, using an inlet port formed through a wall of the pressurized foaming blender, a pressurized gas and a surfactant to the cement composition to produce a foam cement composition; and
obtaining, using an outlet port on the pressurized foaming blender, the foam cement composition.

16. The method of claim 15, wherein the pressurized gas provided to the cement composition has a pressure of 1000 psi or less.

17. The method of claim 15, wherein the pressurized gas comprises nitrogen, air, carbon dioxide combinations therein.

18. The method of claim 15, wherein the pre-mixing blender is a non-pressurized blender.

19. The method of claim 15, wherein providing the pressurized gas and the surfactant to the cement composition further comprises providing the pressurized gas to the pressurized foaming blender while mixing.

20. The method of claim 15, wherein the pressurized gas and the surfactant are provided to the cement composition before mixing the cement composition.
